(19) United States
(12) Patent Application Publication
(10) Pub. No.: US 2013/0321719 A1
(43) Pub. Date: Dec. 5, 2013

(54) ELECTRONIC DEVICE AND METHOD FOR MANUFACTURING SAME

(71) Applicants: Yukihiro Sumida, Osaka (JP); Shun Minamizono, Osaka (JP)

(72) Inventors: Yukihiro Sumida, Osaka (JP); Shun Minamizono, Osaka (JP)

(73) Assignee: SHARP KABUSHIKI KAISHA, Osaka (JP)

(21) Appl. No.: 13/985,929

(22) PCT Filed: Feb. 16, 2012
(86) PCT No.: PCT/JP2012/001035

§ 371 Date: Aug. 16, 2013

(30) Foreign Application Priority Data
Feb. 22, 2011 (JP) 2011-035724

(51) Int. Cl. G02F 1/1333

(52) U.S. Cl. CPC G02F 1/13338
USPC 349/12; 29/825

(57) ABSTRACT

An electronic device provided with: an in-plane switching liquid crystal display device (70a) that is provided with a first substrate (30a) having a terminal region (T) that is provided with a ground terminal (21a), a second substrate (40a) that is arranged so as to face the first substrate (30a), a liquid crystal layer (45) that is arranged between the first substrate (30a) and the second substrate (40a), and a transparent conductive film (51) that is provided on a surface of the second substrate (40a), the surface being on the reverse side of the liquid crystal layer (45)-side surface, and connected to the ground terminal (21a) via a conductive member (54) that is formed from a conductive paste; and a touch panel that is provided on the second substrate (40a) side of the liquid crystal display device (70a). The first substrate (30a) or the second substrate (40a) is provided with an alignment mark (31c) on the liquid crystal layer (45)-side surface. The electronic device is provided with an inflow stopper (47) between the conductive member (54) and the alignment mark (31c) for the purpose of restricting inflow of the conductive paste into the alignment mark (31c).

### TECHNICAL FIELD

The present invention relates to an electronic device and a method for manufacturing the same, and particularly relates to an electronic device that includes a lateral electric field-type liquid crystal display device provided with a touch panel, and a method for manufacturing the same.

### BACKGROUND ART

A lateral electric field-type liquid crystal display device includes a thin film transistor (also referred to as “TFT” below) substrate provided as an electrode substrate, a color filter (also referred to as “CF” below) substrate provided as a non-electrode substrate facing the TFT substrate, and a liquid crystal layer interposed between the TFT substrate and the CF substrate, for example, and by applying a lateral (direction along the substrate surface) electric field to the liquid crystal layer, the transmittance of light through the liquid crystal layer is adjusted for each subpixel, which is the smallest image unit, thereby performing display.

In Patent Document 1, for example, in a lateral electric field-type liquid crystal display device that includes a liquid crystal display panel provided with a pair of transparent substrates facing each other through a liquid crystal layer, and a backlight unit for transmitting light to the display surface of the liquid crystal display panel, the transparent substrate of a liquid crystal display panel further from the backlight unit has a conductive layer formed on a surface thereof opposite to the liquid crystal layer, the conductive layer being transparent at least in portions corresponding to the pixel-forming region, and thus, even if a high electric potential such as static electricity from the outside is present on the surface of the liquid crystal display panel, it is possible to prevent display defects.

### RELATED ART DOCUMENT

### Patent Document

Patent Document 1: Japanese Patent Application Laid-Open Publication No. H9-105918

### SUMMARY OF THE INVENTION

### Problems to be Solved by the Invention

In recent years, among electronic devices that include a liquid crystal display device, there has been attention on electronic devices provided with touch panels for performing input operations by touching icons and the like displayed on the display surface of the liquid crystal display device through the touch panel, for example. In an electronic device that includes a liquid crystal display device provided with a touch panel, in many cases, various minute input operations are conducted through the touch panel on a high resolution display surface. Thus, it is necessary to fix the touch panel and the liquid crystal display device to each other such that the positions thereof match precisely. Therefore, when manufacturing an electronic device including a liquid crystal display device provided with a touch panel, an alignment mark is provided on the edge of the TFT substrate or the CF substrate, for example, and by optically reading in the alignment mark, the position of the liquid crystal display device is detected, allowing the touch panel and the liquid crystal display device to be assembled such that the positions thereof match precisely.

In a lateral electric field-type liquid crystal display device, static electricity from the outside can result in lower contrast due to black being displayed lighter than it should be in normally black display mode, and display unevenness in normally white display mode. Therefore, as in Patent Document 1, in many cases, a buildup of electrical charge is mitigated by providing a transparent conductive film on the viewer side surface of the CF substrate and connecting the transparent conductive film to a grounded ground terminal on the TFT substrate through a conductive paste, for example.

In an electronic device that includes a lateral electric field-type liquid crystal display device provided with a touch panel, the conductive paste for connecting the transparent conductive film provided on the CF substrate to the ground terminal provided on the TFT substrate can flow into a region of the TFT substrate or the CF substrate where the alignment mark is provided, for example, which contaminates the alignment mark. If this happens, the alignment mark cannot be read in optically in a precise manner, which makes it difficult to precisely match the positions of the liquid crystal display device and the touch panel.

The present invention was made in view of this situation, and an object thereof is to precisely match the positions of the touch panel and the lateral electric field-type liquid crystal display device.

### Means for Solving the Problems

In order to achieve the above-mentioned object, in the present invention, an inflow stopper for restricting the flow of the conductive paste into the alignment mark is provided between the conductive member made from the conductive paste and the alignment mark.

Specifically, an electronic device according to the present invention includes: a lateral electric field-type liquid crystal display device that includes: a first substrate having a terminal region provided with a ground terminal; a second substrate provided to face the first substrate such that the terminal region is exposed; a liquid crystal layer interposed between the first substrate and the second substrate; a sealing member provided in a frame shape between the first substrate and the second substrate in order to bond together the first substrate and the second substrate while sealing in the liquid crystal layer; and a transparent conductive film provided on a surface of the second substrate opposite to the liquid crystal layer and connected to the ground terminal through a conductive member made from a conductive paste, the lateral electric field-type liquid crystal display device performing display by generating an electric field in the liquid crystal layer in a direction along a surface of the first substrate; a touch panel on the liquid crystal display device on a side thereof of the second substrate; and an alignment mark on a side of the first substrate or the second substrate that faces the liquid crystal layer for matching positions of the liquid crystal display device and the touch panel, wherein an inflow stopper for restricting a flow of the conductive paste into the alignment mark is provided between the conductive member and the alignment mark.

According to the configuration above, the ground terminal provided on the first substrate is connected to the transparent conductive film provided on the second substrate through the conductive member, and thus, the transparent conductive film provided on the second substrate is grounded, and in an electronic device provided with a lateral electric field-type liquid crystal display device on which a touch panel is mounted, display anomalies due to a buildup of electrical charge such as a decrease in contrast or display unevenness are mitigated. The inflow stopper for restricting a flow of conductive paste into the alignment mark is provided between the conductive member made from the conductive paste and the alignment mark provided on the first substrate or the second substrate for matching the positions of the liquid crystal display device and the touch panel, thus restricting movement of the conductive paste towards the alignment mark. Therefore, contamination of the alignment mark due to the conductive paste is mitigated, thus allowing the alignment mark to be optically read in precisely. As a result, the position of the liquid crystal display device is precisely detected, thus allowing the touch panel and the lateral electric field-type liquid crystal display device to be precisely matched in position.

The inflow stopper may be made of an insulating resin.

According to the configuration above, the inflow stopper is made of an insulating resin, and thus, the inflow stopper is specifically made using a resin that fills an area of the first substrate or the second substrate so as to cover the alignment mark from the outside, a sealing member bonding together the first substrate and the second substrate, or the like, for example.

The alignment mark may be provided on an inner side of the sealing member, and the inflow stopper may be made of a portion of the sealing member.

According to the configuration above, the inflow stopper is made of a portion of the sealing member, and thus, an inflow stopper is formed while mitigating an increase in the number of manufacturing steps.

The sealing member may extend along a periphery of the alignment mark, and the inflow stopper may be made of an extended portion of the sealing member.

According to the configuration above, the inflow stopper is made of an extended portion of the sealing member, and thus, an inflow stopper is formed while mitigating an increase in the number of manufacturing steps.

A method for manufacturing an electronic device of the present invention includes: making a liquid crystal display panel to be a lateral electric field-type liquid crystal display device, the liquid crystal display panel including: a first substrate having a terminal region provided with a ground terminal; a second substrate provided facing the first substrate such that the terminal region is exposed; a liquid crystal layer interposed between the first substrate and the second substrate; a sealing member provided in a frame shape between the first substrate and the second substrate in order to bond together the first substrate and the second substrate while sealing in the liquid crystal layer; and an alignment mark provided on a side of the first substrate or the second substrate facing the liquid crystal layer, the lateral electric field-type liquid crystal display device performing display by generating an electric field in the liquid crystal layer in a direction along a surface of the first substrate; forming a transparent conductive film on a surface of the second substrate of the liquid crystal display panel opposite to the liquid crystal layer; forming a conductive member for completing the liquid crystal display device by disposing a conductive paste between the ground terminal and the transparent conductive film and curing the conductive paste to form the conductive member, thereby connecting the ground terminal to the transparent conductive film; and attaching a touch panel by optically reading the alignment mark, detecting a position of the completed liquid crystal display device, matching the position of the liquid crystal display device to a position of the touch panel, and fixing the liquid crystal display device and the touch panel to each other, wherein the method further includes, before the step of forming a conductive member, forming an inflow stopper for restricting a flow of the conductive paste into the alignment mark between regions where the alignment mark and the conductive member are respectively formed.

According to the method above, by performing the step of forming a conductive member, the ground terminal provided on the first substrate is connected to the transparent conductive film provided on the second substrate through the conductive member, and thus, the transparent conductive film provided on the second substrate is grounded. Therefore, in an electronic device provided with a lateral electric field-type liquid crystal display device provided with a touch panel, display anomalies due to a buildup of electrical charge such as a decrease in contrast or display unevenness are mitigated. In the step of forming an inflow stopper conducted before the step of forming a conductive member, the inflow stopper for restricting a flow of conductive paste into the alignment mark is provided between the conductive member made by curing the conductive paste and the alignment mark provided on the first substrate or the second substrate for matching the positions of the liquid crystal display device and the touch panel. Therefore, movement of the conductive paste towards the alignment mark is restricted. Thus, in the step of forming a conductive member, contamination of the alignment mark due to the conductive paste is mitigated, allowing the alignment mark to be optically read precisely in the step of attaching a touch panel. As a result, in the step of attaching a touch panel, the position of the liquid crystal display device is precisely detected, allowing the touch panel and the lateral electric field-type liquid crystal display device to be precisely matched in position.

In the step of forming an inflow stopper, the inflow stopper may be formed on the first substrate or the second substrate provided with the alignment mark.

According to the method above, in the step of forming an inflow stopper, an inflow stopper is formed on the first substrate or the second substrate provided with the alignment mark, and thus, the alignment mark and the inflow stopper are formed on the same substrate, allowing the inflow stopper to be formed with a high degree of accuracy in the vicinity of the alignment mark.

The process of making a liquid crystal display panel may include the step of forming an inflow stopper, and the inflow stopper may be one portion of the sealing member or an extended portion of the sealing member.

According to the configuration above, the inflow stopper is a portion or an extended portion of the sealing member, and thus, the inflow stopper is formed while mitigating an increase in the number of manufacturing steps.

In the process of making a liquid crystal display panel, the sealing member may be drawn on the first substrate or the second substrate provided with the alignment mark.

According to the method above, in the process of making a liquid crystal display panel, the inflow stopper is formed by drawing the sealing member, and thus, the inflow stopper is formed simply by modifying the path of the dispenser for dispensing the sealing member when drawing the sealing member, for example.

### Effects of the Invention

According to the present invention, an inflow stopper for restricting the flow of a conductive paste into an alignment mark is provided between a conductive member made from the conductive paste and the alignment mark, and thus, it is possible to precisely match the positions of the touch panel to the lateral electric field-type liquid crystal display device.

### BRIEF DESCRIPTION OF THE DRAWINGS

FIG. 1 is a plan view that shows a liquid crystal display device included in an electronic device according to Embodiment 1.

FIG. 2 is a first side view of the electronic device according to Embodiment 1.

FIG. 3 is a second side view of the electronic device according to Embodiment 1.

FIG. 4 is a cross-sectional view of the liquid crystal display device according to Embodiment 1.

FIG. 5 is a plan view that shows a TFT substrate included in the liquid crystal display device according to Embodiment 1.

FIG. 6 is a cross-sectional view of the TFT substrate along the line VI-VI in FIG. 5.

FIG. 7 is a cross-sectional view that shows a CF substrate included in the liquid crystal display device according to Embodiment 1.

FIG. 8 is a plan view of a liquid crystal display device included in an electronic device according to Embodiment 2.

FIG. 9 is a first side view of the electronic device according to Embodiment 2.

FIG. 10 is a second side view of the electronic device according to Embodiment 2.

FIG. 11 is a cross-sectional view of the liquid crystal display device according to Embodiment 2.

FIG. 12 is a descriptive view that shows plan views of some manufacturing steps of the electronic device according to Embodiment 2.

FIG. 13 is a plan view of a liquid crystal display device included in an electronic device according to Embodiment 3.

FIG. 14 is a first side view of the electronic device according to Embodiment 3.

FIG. 15 is a second side view of the electronic device according to Embodiment 3.

FIG. 16 is a cross-sectional view of the liquid crystal display device according to Embodiment 3.

FIG. 17 is a descriptive view that shows plan views of some manufacturing steps of the electronic device according to Embodiment 3.

### DETAILED DESCRIPTION OF EMBODIMENTS

Embodiments of the present invention will be described in detail below with reference to drawings. The present invention is not limited to the embodiments below.

### Embodiment 1

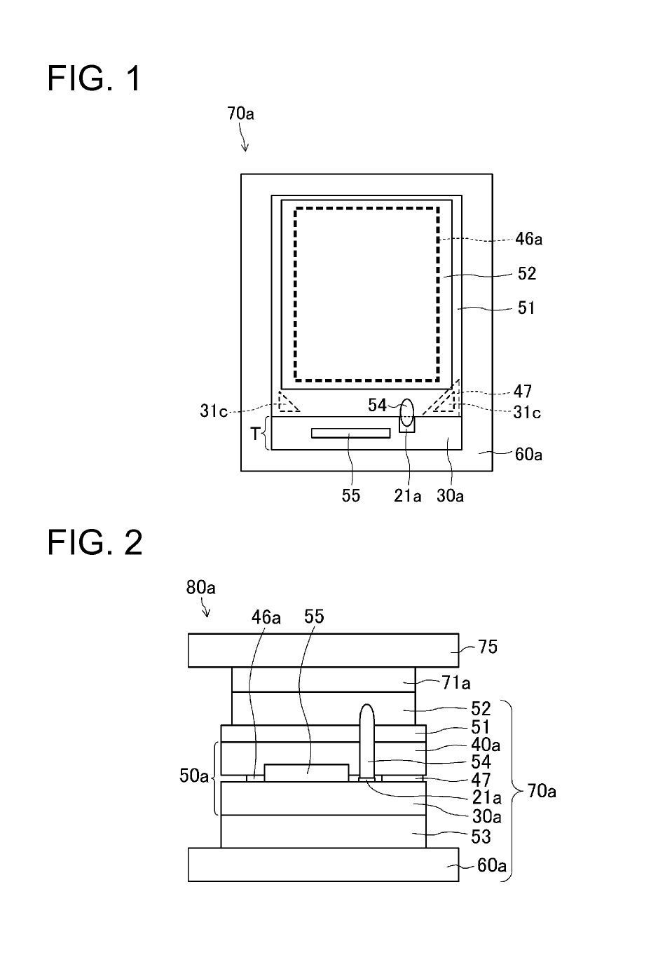

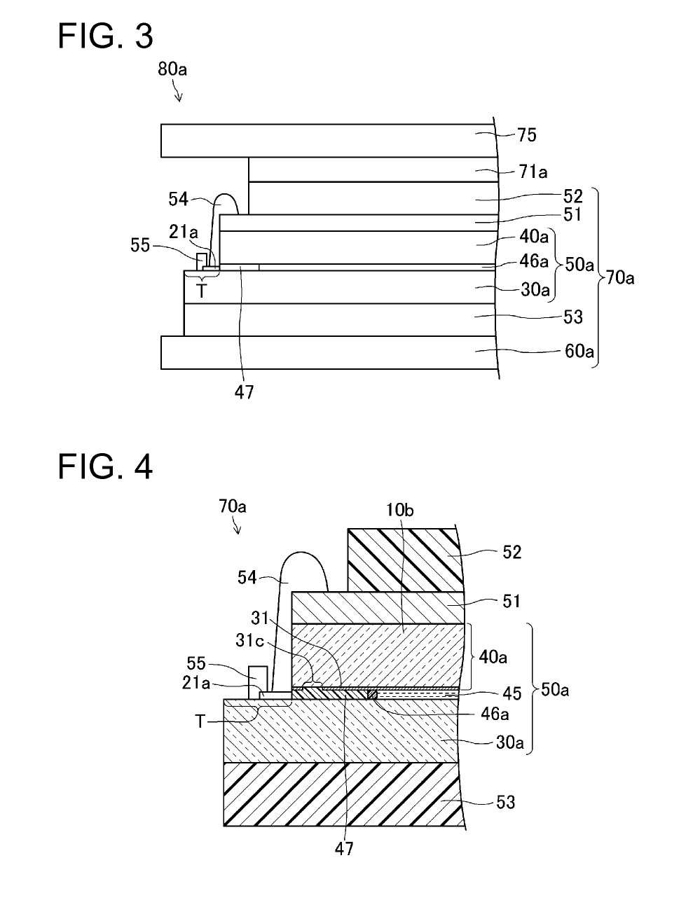

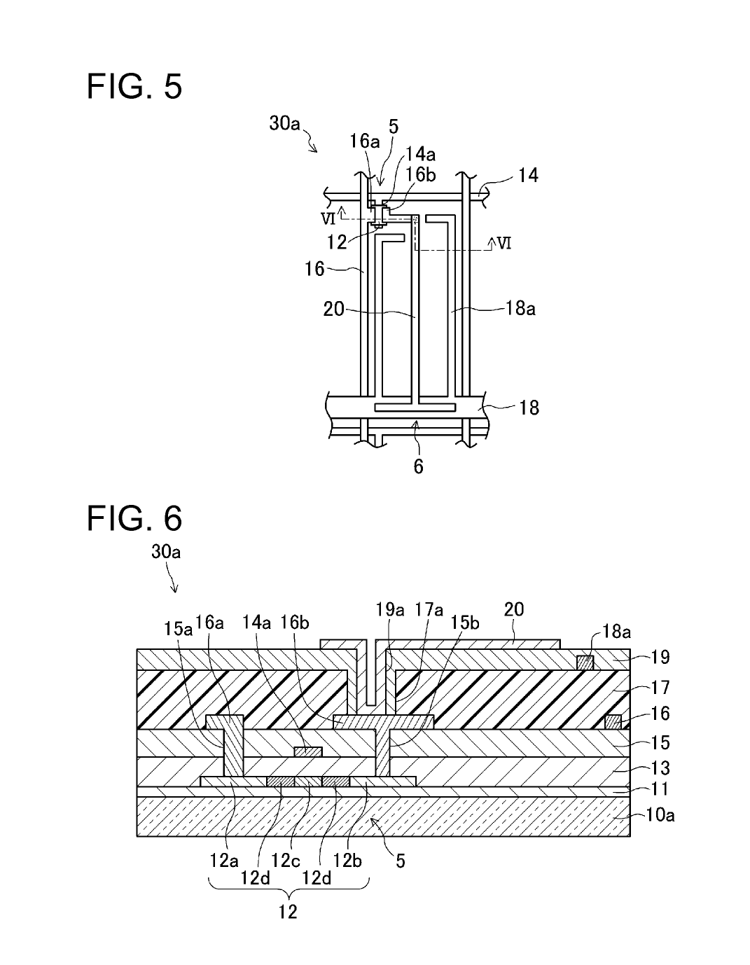

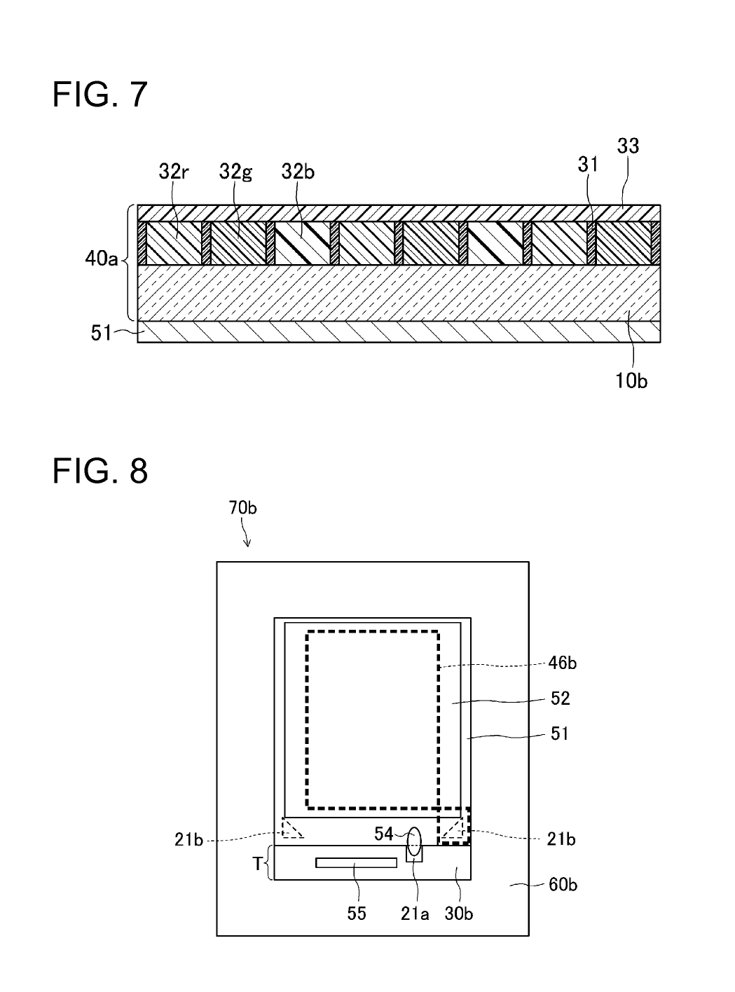

FIGS. 1 to 7 show Embodiment 1 of an electronic device and a method for manufacturing the same according to the present invention. Specifically, FIG. 1 is a plan view of a liquid crystal display device 70a included in an electronic device of the present embodiment. FIG. 2 is a first side view of an electronic device 80a that includes the liquid crystal display device 70a viewed from the lower side of FIG. 1, and FIG. 3 is a second side view of the electronic device 80a viewed from the right side of FIG. 1. FIG. 4 is a cross-sectional view of a substrate edge of the liquid crystal display device 70a. FIG. 5 is a plan view of a TFT substrate 30a included in the liquid crystal display device 70a, and FIG. 6 is a cross-sectional view of the TFT substrate 30a along the line VI-VI in FIG. 5. FIG. 7 is a cross-sectional view of a CF substrate 40a included in the liquid crystal display device 70a.

As shown in FIGS. 2 and 3, the electronic device 80a includes the liquid crystal display device 70a having a liquid crystal display panel 50a, and a touch panel 75 provided on the liquid crystal display device 70a through an adhesive layer 71a.

As shown in FIGS. 2 to 4, the liquid crystal display panel 50a includes the TFT substrate 30a provided as a first substrate, the CF substrate 40a provided as a second substrate facing the TFT substrate 30a, a liquid crystal layer 45 interposed between the TFT substrate 30a and the CF substrate 40a, and a sealing member 46a (refer to FIG. 1) that is provided in a frame shape in order to bond together the TFT substrate 30a and the CF substrate 40a, and to seal in the liquid crystal layer 45.

As shown in FIGS. 1 to 4, the liquid crystal display device 70a includes a liquid crystal display panel 50a, a transparent conductive film 51 provided on a surface of the CF substrate 40a of the liquid crystal display panel 50a opposite to the liquid crystal layer 45, a front polarizing plate 52 provided on the CF substrate 40a side surface of the liquid crystal display panel 50a through the transparent conductive film 51, a rear polarizing plate 53 provided on the TFT substrate 30a side surface of the liquid crystal display panel 50a, and a backlight unit 60a provided on the liquid crystal display panel 50a through the rear polarizing plate 53.

As shown in FIGS. 5 and 6, the TFT substrate 30a includes: an insulating substrate 10a; a plurality of gate lines 14 provided on the insulating substrate 10 to extend in parallel with each other; a plurality of source lines 16 provided to extend in parallel with each other and intersecting perpendicularly with the respective gate lines 14; a plurality of TFTs 5, each of which is provided at each intersection point between each gate line 14 and each source line 16, or in other words, at each subpixel; a planarizing film 17 provided to cover the respective TFTs 5; a plurality of capacitance lines 18 provided on the planarizing film 17 to extend in parallel with each other in the direction that the respective gate lines 14 extend; a capacitance insulating film 19 provided to cover the respective capacitance lines 18; a plurality of pixel electrodes 20 respectively provided on the capacitance insulating film 19 in a T shape at the respective subpixels and connected to the respective TFTs 5; and an alignment film (not shown in drawings) provided to cover the respective pixel electrodes 20. As shown in FIG. 5, the pixel electrode 20 forms an auxiliary capacitance 6 with the capacitance line 18 by overlapping the capacitance line 18 through the capacitance insulating film 19. Also, as shown in FIG. 5, the capacitance line 18 includes a pair of opposite electrodes 18a protruding towards the side in an L shape so as to respectively extend between the source line 16 and the pixel electrode 20 for each subpixel.

As shown in FIGS. 1 to 4, the TFT substrate 30a is provided with a terminal region T that is not covered by the CF substrate 40a, and the terminal region T is provided with a ground terminal 21a that is directly or indirectly grounded and a driver 55 connected to the respective gate lines 14 and the respective source lines 16. In FIGS. 2 to 4, the ground terminal 21a is shown in an exaggerated view in which it protrudes from the surface of the display region (region on the inner side of the sealing member 46a) of the TFT substrate 30a, but the ground terminal 21a is formed of at least one conductive layer included in the TFT substrate 30a, and thus, does not protrude from the surface of the display region.

As shown in FIGS. 5 and 6, the TFT 5 includes: a semiconductor layer 12 that is provided on the insulating substrate 10a through a base coat film 11 and that has a source region 12a, a drain region 12b, a channel region 12c, and LDD (lightly doped drain) regions 12d; a gate insulating film 13 provided to cover the semiconductor layer 12; a gate electrode 14a provided on the gate insulating film 13, overlapping the channel region 12c; an interlayer insulating film 15 provided to cover the gate electrode 14a; and a source electrode 16a and a drain electrode 16b provided on the interlayer insulating film 15 at a distance from each other.

As shown in FIG. 5, the gate electrode 14a is a projection that projects from each gate line 14 from the side thereof.

As shown in FIG. 5, the source electrode 16a is a portion of each source line 16 that projects from the side thereof. As shown in FIG. 6, the source electrode 16a is connected to the source region 12a of the semiconductor layer 12 through an opening 15a formed in the gate insulating film 13 and the interlayer insulating film 15.

As shown in FIG. 6, the drain electrode 16b is connected to the drain region 12b of the semiconductor layer 12 through an opening 15b formed in the gate insulating film 13 and the interlayer insulating film 15. As shown in FIGS. 5 and 6, the drain electrode 16b is connected to the pixel electrode 20 through an opening 17a formed in the planarizing film 17 and an opening 19a formed in the interlayer insulating film 19.

As shown in FIG. 7, the CF substrate 40a includes: an insulating substrate 10b; a black matrix 31 provided in a frame shape and in a grid pattern within the frame shape on the insulating substrate 10b; red layers 32r, green layers 32g, and blue layers 32b respectively provided within the respective grids of the black matrix 31; an overcoat film 33 provided to cover the black matrix 31, the red layers 32r, the green layers 32g, and the blue layers 32b; a plurality of photospacers (not shown in drawings) provided in columnar shapes on the overcoat film 33; and an alignment film (not shown in drawings) provided to cover the overcoat film 33. In portions of the black matrix 31 formed in a frame shape, as shown in FIGS. 1 and 4, a pair of openings 31c having a right triangular shape in a plan view are provided as alignment marks for matching the positions of the liquid crystal display device 70a and the touch panel 75. In the present embodiment, an example was shown in which the CF substrate 40a has three colored layers of R (red), G (green), and B (blue), but the CF substrate may have four or more colored layers such as a configuration of RGB+Y (yellow).

As shown in FIGS. 1 to 4, a conductive member 54 made from a conductive paste such as a silver paste for connecting the transparent conductive film 51 to the ground terminal 21a is provided on a portion of an edge of the front surface of the transparent conductive film 51 provided on the CF substrate 40a, the side face continuous therewith, and the front surface of the ground terminal 21a. Between the TFT substrate 30a and the CF substrate 40a, as shown in FIGS. 1 to 4, on the outer side of the sealing member 46a, a resin layer 47 made of a transparent insulating resin is provided to cover the opening 31c as an inflow stopper for restricting the flow of the conductive paste into the opening 31c in the black matrix 31. In the present embodiment, an example was shown of a resin layer 47 made of a transparent insulating resin, but as long as the opening 31c of the black matrix 31 can be read optically in a precise manner even when the resin layer 47 covers the entirety of the opening 31c, for example, the resin layer 47 may be colored.

The liquid crystal layer 45 is made of a nematic liquid crystal material or the like in which a liquid crystal compound having positive dielectric anisotropy and a liquid crystal compound having negative dielectric anisotropy are mixed together, cancelling out the dielectric anisotropy, for example.

The touch panel 75 includes a transparent electrode (not shown in drawings) provided in a rectangular shape on the insulating substrate, and four lead-out wiring lines (not shown in drawings) drawn from the four corners of the transparent electrode, for example, thus constituting a capacitive-type touch panel. In the present embodiment, an example was shown of a capacitive-type touch panel 75, but the touch panel 75 may be another type of touch panel such as a resistive film touch panel, for example.

The backlight unit 60a includes a thin case (not shown in drawings) that is open on the upper side; a plate-shaped light guide plate (not shown in drawings) provided inside the case; a plate-shaped reflective sheet (not shown in drawings) provided below the light guide plate; a light source (not shown in drawings) such as a fluorescent lamp provided inside the case and disposed on a side of the light guide plate; a reflector (not shown in drawings) provided inside the case and disposed as a vertically split cylinder surrounding the light source; and optical sheets (not shown in drawings) such as a lens sheet and a diffusion sheet provided on the upper surface of the light guide plate, for example. In the present embodiment, a linear light source such as a fluorescent lamp was used as an example of a light source, but the light source may be a plurality of LEDs (light emitting diodes).

The electronic device 80a of the configuration above forms an electric field in the liquid crystal layer 45 through the pixel electrodes 20 and the opposite electrodes 18a in a direction (lateral direction) along the surface of the TFT substrate 30a, thereby performing display by adjusting the transmittance of light through the liquid crystal layer 45 for each subpixel, and detecting a touch position based on changes in capacitance between the transparent electrode of the touch panel 75 and a fingertip when the fingertip touches the surface of the touch panel 75, for example.

Next, a method for manufacturing the electronic device 80a of the present embodiment will be described. The manufacturing method of the present embodiment includes: a process of making a liquid crystal display panel having a process of making a TFT substrate, a process of making a CF substrate, and a process of bonding the substrates (including a step of forming an inflow stopper); a step of forming a transparent conductive film; a step of forming a conductive member; and a step of attaching a touch panel.

### Process of Making a Liquid Crystal Display Panel

### <Process of Making a TFT Substrate>

First, a base coat film 11 is formed on the insulating substrate 10a such as a glass substrate by forming an inorganic insulating film such as a silicon oxide film (thickness of approximately 100 nm) by plasma CVD (chemical vapor deposition), for example.

Next, on the entire substrate on which the base coat film 11 is formed, an amorphous silicon film (thickness of approximately 50 nm) is formed by plasma CVD, for example, and then, the amorphous silicon film is changed to a polysilicon film by laser annealing, solid phase crystallization, or the like, and by performing photolithography, etching, and resist removal and cleaning on the polysilicon film, the semiconductor layer 12 is formed.

An inorganic insulating film (13) made of a silicon oxide film (thickness of approximately 100 nm) is formed by plasma CVD, for example, on the entire substrate surface on which the semiconductor layer 12 is formed.

Then, on the entire substrate on which the inorganic insulating film (13) is formed, a tantalum nitride film (thickness of approximately 50 nm), a tungsten film (thickness of approximately 350 nm), and the like are formed in that order by sputtering, for example, and by performing photolithography, etching, and resist removal and cleaning on the resultant layered metal film, the gate lines 14 and the gate electrodes 14a are formed.

Next, an impurity of phosphorus or boron is implanted in the semiconductor layer 12 with the gate electrode 14a as a mask.

Then, a resist that is larger than the gate electrode 14a in a plan view is formed over the gate electrode 14a, and with the resist as a mask, an impurity of phosphorus or boron is implanted in the semiconductor layer 12. As a result of the implantation of the impurity, the channel region 12c is formed in a portion of the semiconductor layer 12 corresponding to the gate electrode 14aa, LDD regions 12d with relatively low concentrations of the impurity are formed in portions covered by the resist on both sides of the channel region 12c, and a source region 12a and a drain region 12b with relatively high concentrations of the impurity are formed in portions on both sides of the channel region 12c not covered by the resist. If phosphorus is the impurity implanted in the semiconductor layer 12, an n-type polysilicon TFT in which electrons serve as the carrier for the channel current is formed, and if boron is the impurity implanted in the semiconductor layer 12, a p-type polysilicon TFT in which electron holes serve as the carrier for the channel current is formed.

After the resist is removed, the substrate upon which the source region 12a, the drain region 12b, the channel region 12c, and the LDD regions 12d are formed is heated to 650° C. to 700° C., thus activating the implanted impurity.

Next, an inorganic insulating film (15) such as a silicon oxide film (thickness of approximately 150 nm to 500 nm), for example, is formed by plasma CVD, for example, on the entire substrate having the activated impurity, and by performing photolithography, etching, and resist removal and cleaning on the layered insulating film constituted of the inorganic insulating film (15) and the earlier formed inorganic insulating film (13), openings 15a and 15b are formed therein, thus forming the gate insulating film 13 and the interlayer insulating film 15.

After a titanium film (thickness of approximately 100 nm), an aluminum film (thickness of approximately 500 nm), a titanium film (thickness of approximately 100 nm), and the like are formed in this order by sputtering, for example, on the entire substrate having formed thereon the gate insulating film 13 and the interlayer insulating film 15, photolithography, etching, and resist removal and cleaning are conducted on the resultant layered metal film, thus forming the source lines 16, the source electrodes 16a, and the drain electrodes 16b.

Then, the substrate upon which the source lines 16, the source electrodes 16a, and the drain electrodes 16b are formed is heated to approximately 400° C. to 500° C. in a hydrogen atmosphere, thus terminating dangling bonds in the semiconductor layer 12.

Then, an acrylic photosensitive resin is coated by spin coating or slit coating, for example, to a thickness of approximately 2 μm onto the entire substrate having the semiconductor layer 12 with terminated dangling bonds, and this coated film is exposed, developed, and baked, thus forming a planarizing film 17 having an opening 17a.

Next, a transparent conductive film such as an ITO (indium tin oxide) film (thickness of approximately 100 nm) is formed by sputtering, for example, on the entire substrate having formed thereon the planarizing film 17, and then, photolithography, etching, and resist removal and cleaning are conducted on the transparent conductive film, thus forming the capacitance lines 18 and the opposite electrodes 18a.

Then, an inorganic insulating film such as a silicon oxide film (thickness of approximately 150 nm to 500 nm), for example, is formed by plasma CVD, for example, on the entire substrate having formed thereon the capacitance lines 18 and the opposite electrodes 18a, and by performing photolithography, etching, and resist removal and cleaning on the inorganic insulating film, the capacitance insulating film 19 having the opening 19a is formed.

Then, after a transparent conductive film such as an ITO film (thickness of approximately 100 nm) is formed by sputtering, for example, on the entire substrate having formed thereon the capacitance insulating film 19, photolithography, etching, and resist removal and cleaning are conducted on the transparent conductive film, thus forming the pixel electrodes 20.

Lastly, a polyimide resin film is coated by printing, for example, onto the entire substrate having formed thereon the pixel electrodes 20, and baking and rubbing treatment are conducted on the coated film, thus forming the alignment film with a thickness of approximately 100 nm.

The TFT substrate 30a can be manufactured in the above-mentioned manner. The ground terminal 21a on the TFT substrate 30a is formed using at least one of the processes by which the gate lines 14, the source lines 16, the capacitance lines 18, and the pixel electrodes 20 are formed.

### <Process of Making the CF Substrate>

First, an acrylic photosensitive resin having microparticles such as carbon dispersed therein is coated by spin coating or slit coating, for example, onto the entire substrate of the insulating substrate 10b such as a glass substrate, and by performing exposure, developing, and baking on the coated film, a black matrix 31 with a thickness of approximately 2 μm having openings 31c is formed.

Next, an acrylic photosensitive resin colored red, green, or blue is coated by spin coating or slit coating, for example, onto the entire substrate having formed thereon the black matrix 31, and by performing exposure, developing, and baking on the coated film, a colored layer of a selected color (red layer 32r, for example) is formed at a thickness of approximately 2 μm. Similar steps are repeated for the other two colors, thus forming the colored layers of the other two colors (green layer 32g and blue layer 32b, for example) at a thickness of approximately 2 μm.

Next, an organic insulating film such as an acrylic resin is formed by spin coating or slit coating, for example, onto the substrate having formed thereon the red layer 32r, the green layer 32g, and the blue layer 32b, thus forming the overcoat film 33 at a thickness of approximately 1 μm.

Then, a photosensitive resin film is coated by spin coating or slit coating, for example, onto the entire substrate having formed thereon the overcoat film 33, and by performing exposure, developing, and baking on the coated film, photospacers approximately 4 μm in thickness are formed.

Lastly, a polyimide resin film is coated by printing, for example, onto the entire substrate having formed thereon the photospacers, and baking and rubbing treatment are conducted on the coated film, thus forming the alignment film with a thickness of approximately 100 nm.

The CF substrate 40a can be made in the above-mentioned manner.

### <Process of Bonding Substrates>

First, the sealing member 46a made of a resin that is both UV (ultraviolet) curable and heat curable is drawn using a dispenser in a frame shape on the surface of the CF substrate 40a made in the process of making the CF substrate, for example, and then, a liquid crystal material is dripped into the inner side of the sealing material 46a.

Next, the CF substrate 40a on which the liquid crystal material was dripped, and the TFT substrate 30a made in the process of making the TFT substrate, are bonded together in a depressurized state, and by subjecting the bonded body that is bonded in this manner to atmospheric pressure, the front surface and the rear surface of the bonded body are pressurized.

After radiating UV light onto the sealing member 46a sandwiched in the bonded body, the bonded body is heated, thus curing the sealing member 46a.

By separating the bonded body in which the sealing member 46a was cured by dicing, for example, unnecessary portions thereof are removed.

Lastly, a low-viscosity epoxy resin, acrylic resin, or the like is injected using an injecting jig such as a syringe between the TFT substrate 30a and the CF substrate 40a included in the bonded body of which the unnecessary portions were removed, for example, and by curing the injected resin, a resin layer 47 is formed as an inflow stopper (step of forming an inflow stopper).

The liquid crystal display panel 50a can be made in the above-mentioned manner.

### Step of Forming Transparent Conductive Film

The transparent conductive film 51 such as an ITO film (thickness of approximately 100 nm) is formed by vapor deposition, for example, onto the CF substrate 40a side surface of the liquid crystal display panel 50a made in the process of making a liquid crystal display panel.

### Step of Forming Conductive Member

First, after disposing a conductive paste such as a silver paste using a needle-shaped coating jig, for example, between the ground terminal 21a on the TFT substrate 30a and the transparent conductive film 51 on the CF substrate 40a in the liquid crystal display panel 50a on which the transparent conductive film 51 is formed in the step of forming a transparent conductive film, the conductive paste is heated to approximately 80° C. and thereby cured, thus forming the conductive member 54 and connecting the ground terminal 21a to the transparent conductive film 51.

Next, the front polarizing plate 52 and the rear polarizing plate 53 are respectively bonded to the front surface and the rear surface of the liquid crystal display panel 50a having formed thereon the conductive member 54.

In the liquid crystal display panel 50a having bonded thereon the front polarizing plate 52 and the rear polarizing plate 53, the driver 55 is installed in the terminal region T of the TFT substrate 40a, and then the backlight unit 60a is attached, thus completing the liquid crystal display device 70a.

### Step of Attaching Touch Panel

By coating an adhesive on the surface of the front polarizing plate 49a of the liquid crystal display device 70a completed in the step of forming a conductive member, the adhesive layer 71a is formed.

Next, the openings 31c (alignment marks) in the black matrix 31 formed on the CF substrate 40a of the liquid crystal display device 70a having the adhesive layer 71a are read in optically using a CCD (charge coupled device) camera, for example, thereby detecting the position of the liquid crystal display device 70a and then matching the position of the liquid crystal display device 70a and the touch panel 75, and the liquid crystal display device 70a and the touch panel 75 are fixed together through the adhesive layer 71a in the state in which the positions thereof are matched.

In this manner, the electronic device 80a of the present embodiment can be made.

As described above, according to the electronic device 80a and the method for manufacturing the same of the present embodiment, by performing the step of forming a conductive member, the ground terminal 21a provided on the TFT substrate 30a is connected to the transparent conductive film 51 provided on the CF substrate 40a through the conductive member 54, and thus, the transparent conductive film 51 provided on the CF substrate 40a is grounded. Therefore, in the electronic device 80a that includes the lateral electric field-type liquid crystal display device 70a to which the touch panel 75 is mounted, it is possible to mitigate display anomalies due to a buildup of electrical charge such as a decrease in contrast or display unevenness. In the step of forming an inflow stopper conducted before the step of forming a conductive member, the resin layer 47 is formed as an inflow stopper for restricting the flowing of the conductive paste into the opening 31c between the region where the conductive member 54, formed by curing the conductive paste, is disposed, and the opening 31c (of the black matrix 31) provided as alignment mark of the CF substrate 40a in order to match the positions of the liquid crystal display device 70a and the touch panel 75, and thus, it is possible to mitigate movement of the conductive paste towards the opening 31c. Thus, in the step of forming the conductive member, contamination of the opening 31c by the conductive paste can be mitigated, and thus, in the step of attaching a touch panel, it is possible to optically read in the opening 31c with precision. Therefore, in the step of attaching a touch panel, it is possible to precisely detect the position of the liquid crystal display device 70a, and thus, it is possible to precisely match the positions of the touch panel 75 and the lateral electric field-type liquid crystal display device 70a, and to provide an electronic device 80a with a high touch position-detection accuracy.

### Embodiment 2

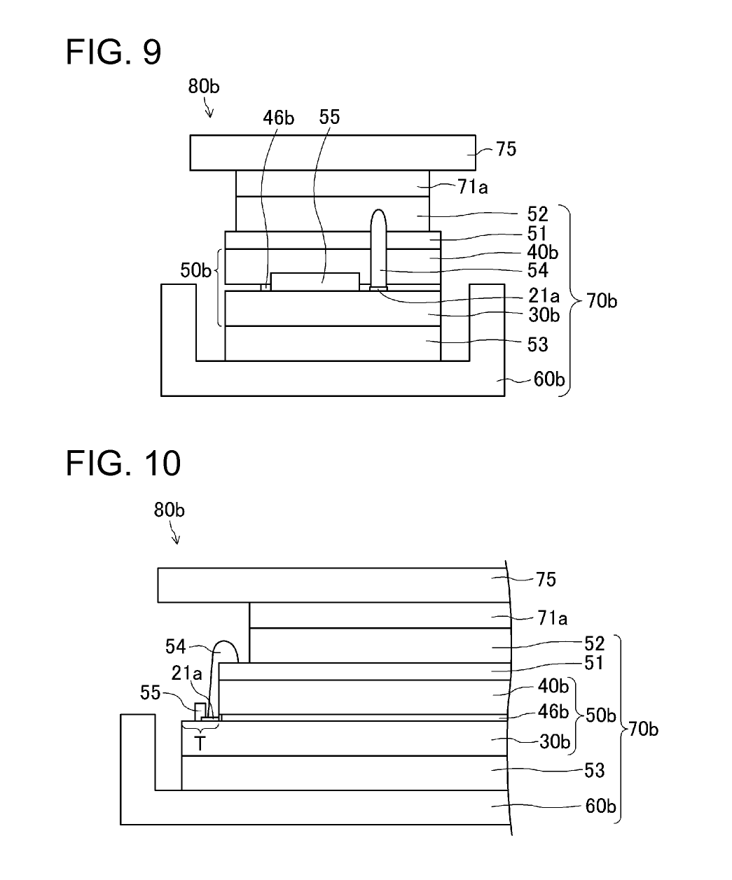

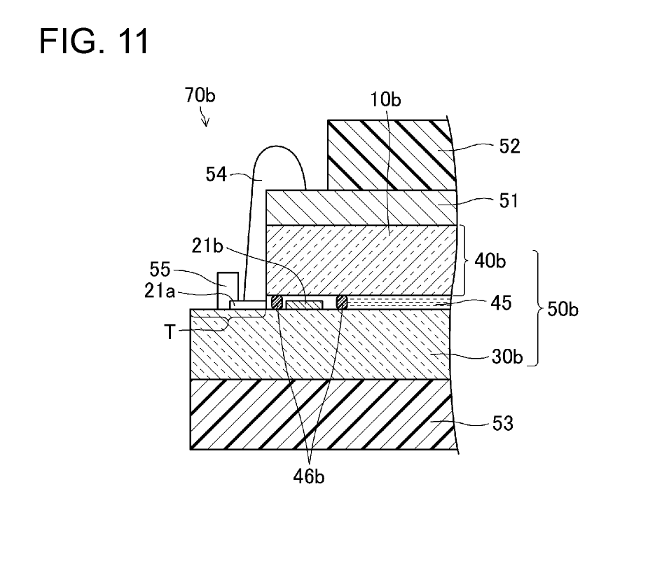

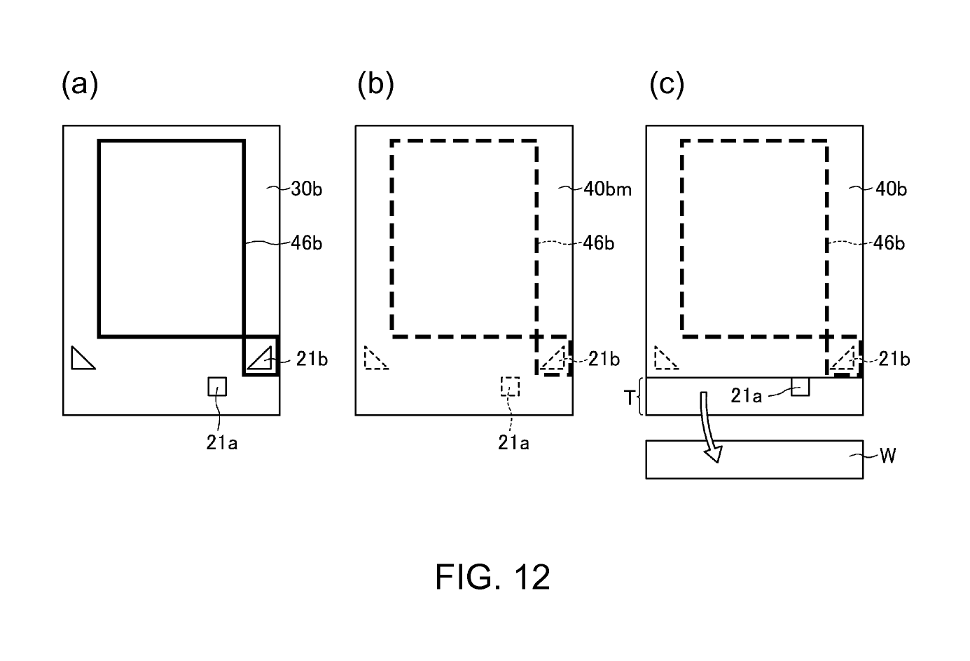

FIGS. 8 to 12 show Embodiment 2 of an electronic device and a method for manufacturing the same according to the present invention. Specifically, FIG. 8 is a plan view of a liquid crystal display device 70b included in an electronic device of the present embodiment. FIG. 9 is a first side view of an electronic device 80b that includes the liquid crystal display device 70b viewed from the lower side of FIG. 8, and FIG. 10 is a second side view of the electronic device 80b viewed from the right side of FIG. 8. FIG. 11 is a cross-sectional view of a substrate edge of the liquid crystal display device 70b. FIG. 12 is a descriptive view that shows plan views of some manufacturing steps for the electronic device 80b. In each embodiment below, the same members as those in FIGS. 1 to 7 are given the same reference characters, and the descriptions thereof are not repeated.

In Embodiment 1, an example was shown of an electronic device 80a in which the inflow stopper is formed by using a resin filled in from the outside, and a method for manufacturing the same, but in the present embodiment, the electronic device 80b in which the inflow stopper is formed using a sealing member, and a method for manufacturing the same, will be shown as an example.

As shown in FIGS. 9 and 10, the electronic device 80b includes the liquid crystal display device 70b having a liquid crystal display panel 50b, and a touch panel 75 provided on the liquid crystal display device 70b through an adhesive layer 71a.

As shown in FIGS. 9 to 11, the liquid crystal display panel 50b includes a TFT substrate 30b provided as a first substrate, a CF substrate 40b provided as a second substrate facing the TFT substrate 30b, a liquid crystal layer 45 interposed between the TFT substrate 30b and the CF substrate 40b, and a sealing member 46b (refer to FIG. 8) that is provided in a frame shape in order to bond together the TFT substrate 30b and the CF substrate 40b while sealing in the liquid crystal layer 45.

As shown in FIGS. 8 to 11, the liquid crystal display device 70b includes: a liquid crystal display panel 50b; a transparent conductive film 51 provided on a surface of the CF substrate 40b of the liquid crystal display panel 50b opposite to the liquid crystal layer 45; a front polarizing plate 52 provided on a surface of the CF substrate 40b of the liquid crystal display panel 50b through the transparent conductive film 51; a rear polarizing plate 53 provided on a surface of the TFT substrate 30b of the liquid crystal display panel 50b; and a backlight unit 60b provided on the liquid crystal display panel 50b through the rear polarizing plate 53.

The TFT substrate 30b is configured in substantially the same manner as the TFT substrate 30a of Embodiment 1, except that, as shown in FIGS. 8 and 11, alignment marks 21b are provided in a region outside of the display region and overlapping the CF substrate 40b.

The CF substrate 40b is configured in substantially the same manner as the CF substrate 40a of Embodiment 1, except that, as shown in FIG. 7, a black matrix is not provided in regions overlapping the alignment marks 21b on the TFT substrate 30b or surrounding regions.

In the liquid crystal display panel 50b (liquid crystal display device 70b), as shown in FIG. 8, the sealing member 46b that surrounds the liquid crystal layer 45 in a frame shape and seals in the liquid crystal layer 45 is extended, and the extended portion thereof surrounds an alignment mark 21b on the TFT substrate 30b, and functions as an inflow stopper for restricting the flow of the conductive paste into the alignment mark 21b. The sealing member 46b has a large ring-shaped portion that is relatively large and surrounds the display region and a small ring-shaped portion that is relatively small and surrounds the alignment mark 21b, and has an overall FIG. 8 shape.

The backlight unit 60b is configured in substantially the same manner as the backlight unit 60a of Embodiment 1, except that, as shown in FIGS. 9 and 10, a case that opens on the upper side is formed thicker.

The electronic device 80b configured as described above forms an electric field in the liquid crystal layer 45 through the pixel electrodes 20 and the opposite electrodes 18a in a direction (lateral direction) along the surface of the TFT substrate 30b, and thus, conducts display by adjusting the transmittance of light through the liquid crystal layer 45 for each subpixel, and detects a touch position when a fingertip touches the surface of the touch panel 75 based on changes in capacitance between the transparent electrode of the touch panel 75 and the fingertip, for example.

Next, a method for manufacturing the electronic device 80b of the present embodiment will be described. The manufacturing method of the present embodiment includes: a process of making a liquid crystal display panel having a process of making a TFT substrate, a process of making a CF substrate, and a process of bonding the substrates (including a step of forming an inflow stopper); a step of forming a transparent conductive film; a step of forming a conductive member; and a step of attaching a touch panel. The TFT substrate 30b can be made by forming the alignment marks 21b using at least one of the steps for forming the gate lines 14, the source lines 16, the capacitance lines 18, and the pixel electrodes 20 in the process of making the TFT substrate of Embodiment 1, and thus, descriptions of the process of making the TFT substrate of the present embodiment will be omitted. The CF substrate 40b can be made by modifying the shape of the black matrix 31 in the process of making the CF substrate of Embodiment 1, and thus, descriptions of the process of making the CF substrate of the present embodiment will be omitted. A step of forming a transparent conductive film, a step of forming a conductive member, and a step of attaching a touch panel of the present embodiment are substantially the same as the step of forming a transparent conductive film, the step of forming a conductive member, and the step of attaching a touch panel of Embodiment 1, and thus, descriptions thereof will be omitted. Therefore, with reference to FIG. 12, the process of bonding the substrates in the process of making a liquid crystal display panel will be described below.

### <Process of Bonding Substrates>

First, on a surface of the TFT substrate 30b made in the process of making a TFT substrate, as shown in FIG. 12(a), the sealing member 46b made of a resin that is both UV curable and heat curable is drawn by a dispenser in a FIG. 8 shape, for example, and then a liquid crystal material (not shown in drawings) is dripped into the inner side of the sealing member 46b (the large ring-shaped portion).

Next, the TFT substrate 30b upon which the liquid crystal material was dripped and a CF mother substrate 40bm made in the process of making a CF substrate are bonded together in a depressurized state as shown in FIG. 12(b), and then the bonded body is subjected to atmospheric pressure, thus pressurizing the front surface and the rear surface of the bonded body. The CF mother substrate 40bm is the CF substrate 40b before an excess substrate W to be described later is split from the CF mother substrate 40bm and removed.

After the sealing member 46b sandwiched within the bonded body is irradiated with UV light, the bonded body is heated, thereby curing the sealing member 46b, and the inflow stopper is constituted of the extended portion of the sealing member 46b (step of forming an inflow stopper).

Lastly, as shown in FIG. 12(c), the bonded body with the cured sealing member 46b is split by dicing, for example, thus removing the excess substrate W. When removing the excess substrate W, the CF mother substrate 40bm is split over the sealing member 46b.

The liquid crystal display panel 50b can be made in the above-mentioned manner.

Next, as in Embodiment 1, the step of forming a transparent conductive film and the step of forming a conductive member are conducted, and the step of attaching a touch panel is conducted by reading in optically the alignment marks 21b on the TFT substrate 30b of the liquid crystal display device 70b, thus completing the electronic device 80b of the present embodiment.

As described above, according to the electronic device 80b and the method for manufacturing the same of the present embodiment, by performing the step of forming a conductive member, the ground terminal 21a provided on the TFT substrate 30b is connected to the transparent conductive film 51 provided on the CF substrate 40b through the conductive member 54, and thus, the transparent conductive film 51 on the CF substrate 40b is grounded, and in the electronic device 80b that includes the lateral electric field-type liquid crystal display device 70b upon which the touch panel 75 is mounted, display anomalies due to a buildup of electrical charge such as a decrease in contrast or display unevenness can be mitigated. In the step of forming an inflow stopper conducted before the step of forming a conductive member, the sealing member 46b that functions as an inflow stopper for restricting the flow of the conductive paste into the alignment mark 21b is formed between the region where the conductive member 54, which is formed by curing the conductive paste, is disposed, and the alignment mark 21b provided on the TFT substrate 30b for matching the position of the liquid crystal display device 70b and the touch panel 75. Therefore, it is possible to mitigate movement of the conductive paste towards the alignment mark 21b. Thus, in the step of forming the conductive member, contamination of the alignment mark 21b by the conductive paste can be mitigated, and therefore, in the step of attaching a touch panel, it is possible to optically read in the alignment mark 21b with precision. As a result, in the step of attaching the touch panel, the position of the liquid crystal display device 70b can be precisely detected, and thus, the touch panel 75 and the lateral electric field-type liquid crystal display device 70b can be precisely matched in position, and it is possible to provide the electronic device 80b with a high touch position-detection accuracy.

According to the method for manufacturing the electronic device 80b of the present embodiment, in the step of forming an inflow stopper, an inflow stopper (sealing member 46b) is formed on the TFT substrate 30b provided with the alignment marks 21b, and thus, the alignment marks 21b and the inflow stopper (sealing member 46b) are formed on the same substrate, and it is possible to form the inflow stopper (sealing member 46b) in the vicinity of the alignment mark 21b with a high degree of accuracy.

According to the method for manufacturing the electronic device 80b of the present embodiment, the process of making a liquid crystal display panel includes the step of forming an inflow stopper, and the inflow stopper is an extended portion of the sealing member 46b. Thus, the inflow stopper (46b) can be formed while mitigating an increase in the number of manufacturing steps, and it is difficult for the material constituting the inflow stopper (46b) to stick to the ground terminal 21a, allowing an excellent connection state to be ensured on the ground terminal 21a.

According to the method for manufacturing the electronic device 80b of the present embodiment, in the process of making a liquid crystal display panel, the inflow stopper (46b) is formed by drawing the sealing member 46b, and thus, it is possible to form the inflow stopper (46b) simply by modifying the path of the dispenser that dispenses the sealing member 46b when drawing the sealing member 46b.

### Embodiment 3

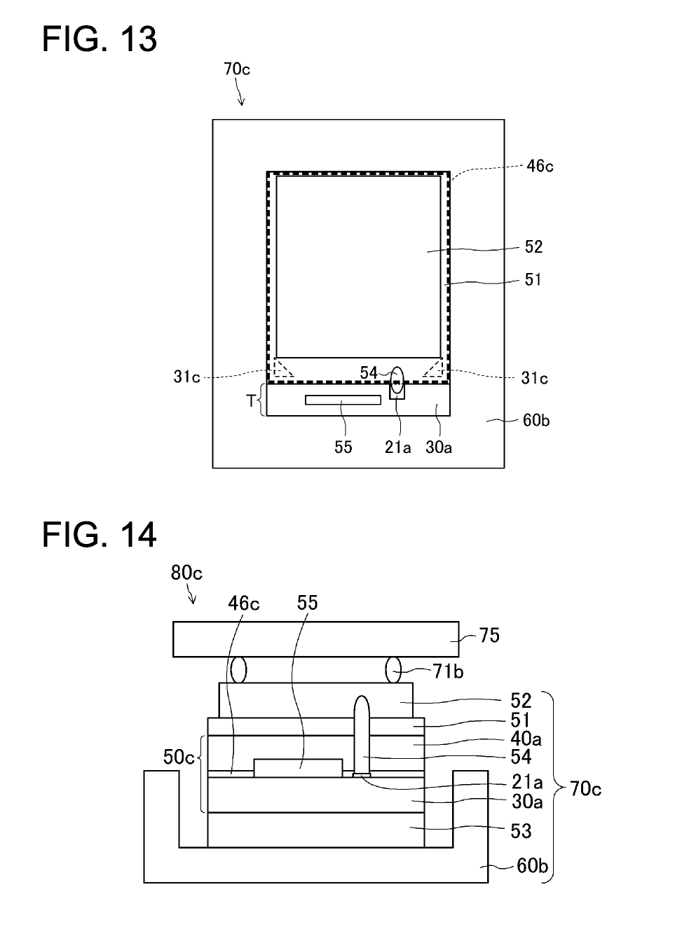

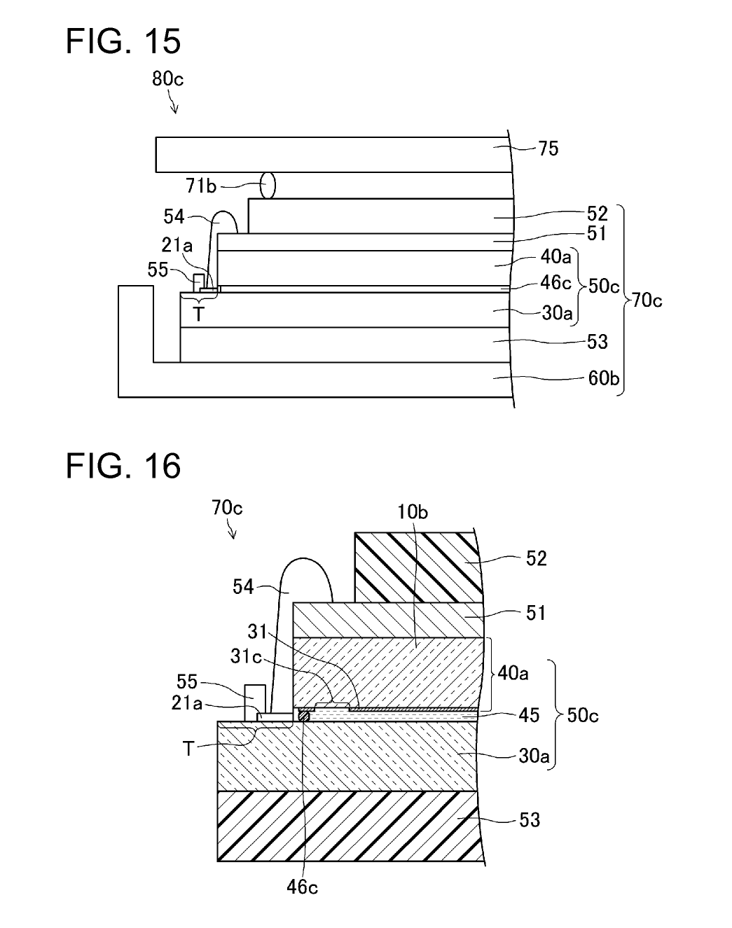

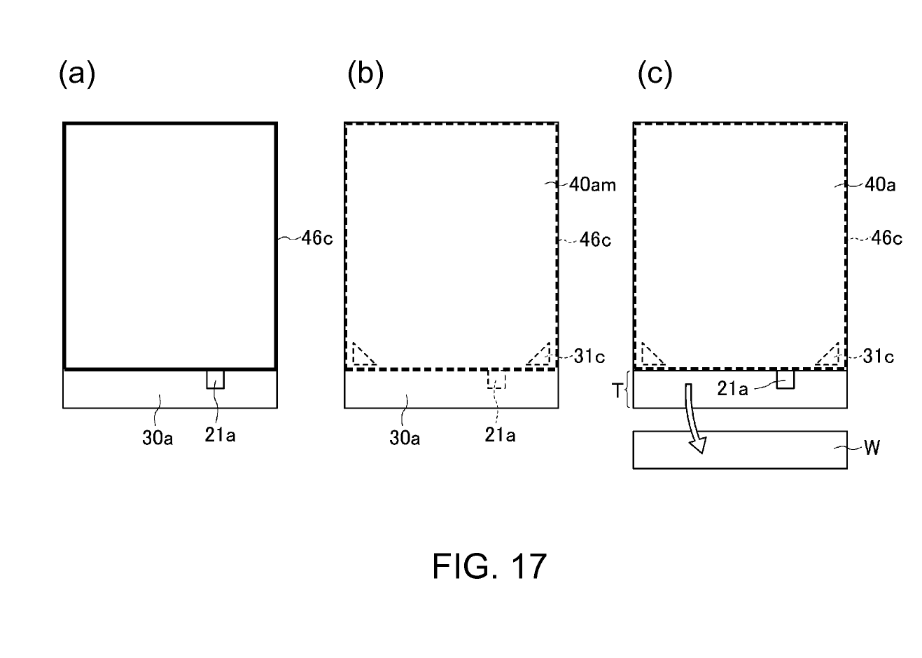

FIGS. 13 to 17 show Embodiment 3 of an electronic device and a method for manufacturing the same according to the present invention. Specifically, FIG. 13 is a plan view of a liquid crystal display device 70c included in an electronic device of the present embodiment. FIG. 14 is a first side view of an electronic device 80c that includes the liquid crystal display device 70c viewed from the lower side of FIG. 13, and FIG. 15 is a second side view of the electronic device 80c viewed from the right side of FIG. 13. FIG. 16 is a cross-sectional view of a substrate edge of the liquid crystal display device 70c. FIG. 17 is a descriptive view that shows plan views of some manufacturing steps for the electronic device 80c.

In Embodiment 2, an example was shown of the electronic device 80a in which the inflow stopper was an extended portion of the sealing member, and the method for manufacturing the same, but in the present embodiment, an example will be shown of the electronic device 80c in which the inflow stopper is formed of a portion of the sealing member, and a method for manufacturing the same.

As shown in FIGS. 14 and 15, the electronic device 80c includes the liquid crystal display device 70c having a liquid crystal display panel 50c, and a touch panel 75 provided on the liquid crystal display device 70c through a double sided tape 71b.

As shown in FIGS. 14 to 16, the liquid crystal display panel 50c includes: a TFT substrate 30a provided as a first substrate; a CF substrate 40a provided as a second substrate facing the TFT substrate 30a; a liquid crystal layer 45 interposed between the TFT substrate 30a and the CF substrate 40a; and a sealing member 46c (refer to FIG. 13) provided in a frame shape for bonding together the TFT substrate 30a and the CF substrate 40a while sealing in the liquid crystal layer 45.

As shown in FIGS. 13 to 16, the liquid crystal display device 70c includes: a liquid crystal display panel 50c; a transparent conductive film 51 provided on a surface of the CF substrate 40a of the liquid crystal display panel 50c opposite to the liquid crystal layer 45; a front polarizing plate 52 provided on a surface of the liquid crystal display panel 50c on the CF substrate 40a side through the transparent conductive film 51; a rear polarizing plate 53 provided on a surface of the liquid crystal display panel 50c on the TFT substrate 30a side; and a backlight unit 60b provided on the liquid crystal display panel 50c through the rear polarizing plate 53.

As shown in FIG. 13, in the liquid crystal display panel 50c (liquid crystal display device 70c), a portion of the sealing member 46c that surrounds the liquid crystal layer 45 in a frame shape sealing in the liquid crystal layer 45 surrounds openings 31c of the black matrix 31 on the CF substrate 30a, the openings 31c being provided as alignment marks, and the sealing member 46c functions as the inflow stopper for restricting the flow of the conductive past into the openings 31c.

The electronic device 80c of the above-mentioned configuration generates an electric field in the liquid crystal layer 45 in a direction (lateral direction) along the surface of the TFT substrate 30a through the pixel electrodes 20 and the opposite electrodes 18a, thereby performing display by adjusting the transmittance of light through the liquid crystal layer 45 for each subpixel, and detects a touch position based on changes in capacitance between the transparent electrode of the touch panel 75 and a fingertip, when a fingertip touches the surface of the touch panel 75, for example.

Next, a method for manufacturing the electronic device 80c of the present embodiment will be described. The manufacturing method of the present embodiment includes: a process of making a liquid crystal display panel having a process of making a TFT substrate, a process of making a CF substrate, and a process of bonding the substrates (including a step of forming an inflow stopper); a step of forming a transparent conductive film; a step of forming a conductive member; and a step of attaching a touch panel. A process of making a TFT substrate, a process of making a CF substrate, a step of forming a transparent conductive layer, a step of forming a conductive member, and a step of attaching a touch panel of the present embodiment are substantially the same as the process of making a TFT substrate, the process of making a CF substrate, the step of forming a transparent conductive layer, the step of forming a conductive member, and the step of attaching a touch panel of Embodiment 1, and thus, descriptions thereof will be omitted. Therefore, with reference to FIG. 17, the process of bonding the substrates in the process of making a liquid crystal display panel will be described below.

### <Process of Bonding Substrates>

First, as shown in FIG. 17(a), after drawing the sealing member 46c made of a resin that is both UV curable and heat curable, for example, in a frame shape using a dispenser, a liquid crystal material (not shown in drawings) is dripped onto the surface of the TFT substrate 30a made in the process of making a TFT substrate, in the inner side of the sealing member 46c.

Next, the TFT substrate 30a upon which the liquid crystal material was dripped and a CF mother substrate 40am made in the process of making a CF substrate are bonded together in a depressurized state as shown in FIG. 17(b), and then the bonded body is subjected to atmospheric pressure, thus pressurizing the front surface and the rear surface of the bonded body. The CF mother substrate 40am is the CF substrate 40a before an excess substrate W to be described later is split from the CF mother substrate 40am and removed.

Then, after radiating UV light onto the sealing member 46c sandwiched in the bonded body, the bonded body is heated, thus curing the sealing member 46c, and an inflow stopper is formed of a portion of the sealing member 46c (step of forming an inflow stopper).

Lastly, as shown in FIG. 17(c), the bonded body with the cured sealing member 46c is split by dicing, for example, thus removing the excess substrate W. When removing the excess substrate W, the CF mother substrate 40am (and the TFT mother substrate) is split over the sealing member 46c.

The liquid crystal display panel 50c can be made in the above-mentioned manner.

Then, as in Embodiment 1, the electronic device 80c of the present embodiment can be manufactured by performing the step of forming a transparent conductive film and the step of forming a conductive member, and performing the step of attaching a touch panel using the double sided tape 71b.

As described above, according to the electronic device 80c and the method for manufacturing the same according to the present embodiment, by performing the step of forming a conductive member, the ground terminal 21a provided on the TFT substrate 30a is connected to the transparent conductive film 51 provided on the CF substrate 40a through the conductive member 54. Thus, the transparent conductive film 51 provided on the CF substrate 40a is grounded, and in the electronic device 80c that includes the lateral electric field-type liquid crystal display device 70c with the touch panel 75 mounted thereon, it is possible to mitigate display anomalies due to a buildup of electrical charge such as a decrease in contrast or display unevenness. In the step of forming an inflow stopper conducted before the step of forming a conductive member, the sealing member 46c functioning as an inflow stopper for restricting the flow of the conductive paste into openings 31c is formed between the region where the conductive member 54, formed by curing the conductive paste, is disposed, and the openings 31c (of the black matrix 31) provided on the CF substrate 40a as alignment marks for matching the position of the liquid crystal display device 70c and the touch panel 75, and thus, it is possible to mitigate movement of the conductive paste towards the opening 31c. Thus, in the step of forming the conductive member, contamination of the openings 31c by the conductive paste can be mitigated, and thus, in the step of attaching a touch panel, it is possible to optically read in the openings 31c with precision. As a result, in the step of attaching a touch panel, the position of the liquid crystal display device 70c is detected precisely, and therefore, it is possible to precisely match the positions of the touch panel 75 and the lateral electric field-type liquid crystal display device 70c, and it is possible to provide an electronic device 80c with a high touch position-detection accuracy.

According to a method for manufacturing the electronic device 80c of the present embodiment, the process of making a liquid crystal display panel includes the step of forming an inflow stopper, and the inflow stopper is a portion of the sealing member 46c, thus allowing the inflow stopper (46c) to be formed while mitigating an increase in the number of manufacturing steps.

According to the method for manufacturing the electronic device 80c of the present embodiment, in the process of making a liquid crystal display panel, the inflow stopper (46c) is formed by drawing the sealing member 46c, and thus, it is possible to form the inflow stopper (46c) simply by modifying the path of the dispenser that dispenses the sealing member 46c when drawing the sealing member 46c.

In the embodiments above, examples were shown of manufacturing methods in which a touch panel is attached to a liquid crystal display device provided with a backlight unit, but a touch panel may be attached to the liquid crystal display device to which the backlight unit is not yet attached, with the backlight unit being attached thereafter.

In the embodiments above, examples were shown of an electronic device being grounded on one side of the terminal region, but the electronic device may be grounded on both sides of the terminal region.

In the embodiments above, examples were shown of techniques for matching the positions of the liquid crystal display device and the touch panel, but the present invention can also be applied to a technique relating to matching the positions of the liquid crystal display device and a protective plate that protects the liquid crystal display device.

In the embodiments above, examples were shown of a TFT substrate in which the electrode of the TFT connected to the pixel electrode was the drain electrode, but the present invention can be applied to a TFT substrate in which the electrode of the TFT connected to the pixel electrode is the source electrode.

### INDUSTRIAL APPLICABILITY

As described above, the touch panel and the lateral electric field-type liquid crystal display device can be precisely matched in position, and thus, the present invention is useful for an electronic device that includes a lateral electric field-type liquid crystal display device on which the touch panel is installed.

### DESCRIPTION OF REFERENCE CHARACTERS

T terminal region
21a ground terminal
21b alignment mark
30a, 30b TFT substrate (first substrate)
31c opening (alignment mark)
40a, 40b CF substrate (second substrate)
45 liquid crystal layer
46a sealing member
46b, 46c sealing member (inflow stopper)
47 resin layer (inflow stopper)
50a to 50c liquid crystal display panel
51 transparent conductive film
54 conductive member (conductive paste)
70a to 70c liquid crystal display device
80a to 80c electronic device

1. An electronic device, comprising:
a lateral electric field-type liquid crystal display device that includes: a first substrate having a terminal region provided with a ground terminal; a second substrate provided to face the first substrate such that the terminal region is exposed; a liquid crystal layer interposed between the first substrate and the second substrate; a sealing member provided in a frame shape between the first substrate and the second substrate in order to bond together the first substrate and the second substrate while sealing in the liquid crystal layer; and a transparent conductive film provided on a surface of the second substrate opposite to the liquid crystal layer and connected to the ground terminal through a conductive member made from a conductive paste, the lateral electric field-type liquid crystal display device performing display by generating an electric field in the liquid crystal layer in a direction along a surface of the first substrate;
a touch panel on the liquid crystal display device on a side thereof of the second substrate; and
an alignment mark on a surface of the first substrate or the second substrate that faces the liquid crystal layer for matching positions of the liquid crystal display device and the touch panel,
wherein an inflow stopper for restricting a flow of the conductive paste into the alignment mark is provided between the conductive member and the alignment mark.

2. The electronic device according to claim 1, wherein the inflow stopper is made of an insulating resin.

3. The electronic device according to claim 1,
wherein the alignment mark is provided on an inner side of the sealing member, and
wherein the inflow stopper is made of a portion of the sealing member.

4. The electronic device according to claim 1,
wherein the sealing member extends along a periphery of the alignment mark, and
wherein the inflow stopper is made of an extended portion of the sealing member.

5. A method for manufacturing an electronic device, comprising:
making a liquid crystal display panel to be a lateral electric field-type liquid crystal display device, the liquid crystal display panel including: a first substrate having a terminal region provided with a ground terminal; a second substrate provided facing the first substrate such that the terminal region is exposed; a liquid crystal layer interposed between the first substrate and the second substrate; a sealing member provided in a frame shape between the first substrate and the second substrate in order to bond together the first substrate and the second substrate while sealing in the liquid crystal layer; and an alignment mark provided on a surface of the first substrate or the second substrate facing the liquid crystal layer, the lateral electric field-type liquid crystal display device performing display by generating an electric field in the liquid crystal layer in a direction along a surface of the first substrate;
forming a transparent conductive film on a surface of the second substrate of the liquid crystal display panel opposite to the liquid crystal layer;
forming a conductive member for completing the liquid crystal display device by disposing a conductive paste between the ground terminal and the transparent conductive film and curing the conductive paste to form the conductive member, thereby connecting the ground terminal to the transparent conductive film; and
attaching a touch panel by optically reading the alignment mark, detecting a position of the completed liquid crystal display device, matching the position of the liquid crystal display device to a position of the touch panel, and fixing the liquid crystal display device and the touch panel to each other,
wherein the method further includes, before the step of forming a conductive member, forming an inflow stopper for restricting a flow of the conductive paste into the alignment mark between the alignment mark and the conductive member.

6. The method for manufacturing an electronic device according to claim 5, wherein, in the step of forming an inflow stopper, the inflow stopper is formed on the first substrate or the second substrate provided with the alignment mark.

7. The method for manufacturing an electronic device according to claim 6,
wherein the process of making a liquid crystal display panel includes the step of forming an inflow stopper, and
wherein the inflow stopper is one portion of the sealing member or an extended portion of the sealing member.

8. The method for manufacturing an electronic device according to claim 7, wherein, in the process of making a liquid crystal display panel, the sealing member is drawn on the first substrate or the second substrate provided with the alignment mark.
